(19) United States
(12) Patent Application Publication
(10) Pub. No.: US 2009/0028401 A1
(43) Pub. Date: Jan. 29, 2009

(54) Radiation image capturing system

(75) Inventors: Tsuyoshi Tanabe, Kanagawa (JP); Eiichi Kito, Kanagawa (JP); Takuya Yoshimi, Kanagawa (JP); Takeshi Kuwabara, Kanagawa (JP); Kazuharu Ueta, Tokyo (JP); Makoto Iriuchijima, Tokyo (JP); Yasunori Ohta, Kanagawa (JP)

Correspondence Address: AKERMAN SENTERFITT, 801 PENNSYLVANIA AVENUE N.W., SUITE 600, WASHINGTON, DC, 20004, US

(73) Assignee: FUJIFILM Corporation, Tokyo (JP)

(21) Appl. No.: 12/219,655

(22) Filed: Jul. 25, 2008

(30) Foreign Application Priority Data
Jul. 26, 2007 (JP) 2007-194510
May 30, 2008 (JP) 2008-143391

(51) Int. Cl. G06K 9/60

(52) U.S. Cl. 382/128

(57) ABSTRACT

Radiation image information detected by a radiation detector of a radiation detecting cassette is compressed by an image compressor, and then transmitted by way of wireless communications to a display device, which displays a compressed image representative of a rough radiation image on a display unit. The radiation image information is stored in an image memory and transmitted by way of wireless communications to a console in which the radiation image information is processed as desired by an image processor. The processed radiation image information is sent by way of wireless communications to the display device, which displays a detailed image in place of the compressed image.

### BACKGROUND OF THE INVENTION

1. Field of the Invention

The present invention relates to a radiation image capturing system having a display device for detecting a radiation that has passed through a subject, converting the detected radiation into radiation image information, and displaying an image based on the radiation image information.

2. Description of the Related Art

In the medical field, there have widely been used radiation image capturing apparatus which apply a radiation to a subject and guide the radiation that has passed through the subject to a radiation conversion panel, which captures a radiation image from the radiation. Known forms of the radiation conversion panel include a conventional radiation film for recording a radiation image by way of exposure, and a stimulable phosphor panel for storing a radiation energy representing a radiation image in a phosphor and reproducing the radiation image as stimulated light by applying stimulating light to the phosphor.

The radiation film with the recorded radiation image is supplied to a developing device to develop the radiation, or the stimulable phosphor panel is supplied to a reading device to read the radiation image as a visible image.

In the operating room or the like, it is necessary to read and display a recorded radiation image immediately from a radiation conversion panel after the radiation image is captured for the purpose of quickly and appropriately treating the patient. As a radiation conversion panel which meets such a requirement, there has been developed a radiation detector having a solid-state detector for converting a radiation directly into an electric signal or converting a radiation into visible light with a scintillator and then converting the visible light into an electric signal to read a detected radiation image.

Heretofore, radiation image capturing systems employing such a radiation detector are disclosed in Japanese Patent No. 3494683, Japanese Laid-Open Patent Publication No. 2007-061386, Japanese Laid-Open Patent Publication No. 2005-296050, and Japanese Laid-Open Patent Publication No. 2002-248095.

According to Japanese Patent No. 3494683, radiation image information detected by a radiation detector is sent to a processor by way of wireless communications, which performs signal processing such as image processing on the supplied radiation image information.

According to Japanese Laid-Open Patent Publication No. 2007-061386, after radiation image information detected by a radiation detector is sent to a processor by way of wireless communications, the processed radiation image information is sent from the processor to a display device by way of wireless communications, so that the display device displays an image based on the supplied radiation image information.

According to Japanese Laid-Open Patent Publication No. 2005-296050, the data size of radiation image information detected by a radiation detector is reduced to generate image data for confirmation, and the image data for confirmation are sent to a display device by way of wireless communications, so that the display device displays an image that is confirmed by the user. Thereafter, the radiation detector is connected to a processor, which reads and processes the radiation image information which is not reduced in data size.

According to Japanese Laid-Open Patent Publication No. 2002-248095, radiation image information detected by a radiation detector is compressed, and the compressed radiation image information is sent through a processor to a display device by way of wireless communications, which displays a preview image based on the compressed radiation image information. After general image features are confirmed with the preview image by the user, the radiation image information which is not compressed is sent to a processor by way of wired communications and processed by the processor.

According to the related art disclosed in Japanese Patent No. 3494683 and Japanese Laid-Open Patent Publication No. 2007-061386, the radiation image information is sent from the radiation detector to the processor by way of wireless communications. Since the radiation image information is processed by the processor before being displayed, if the amount of the radiation image information is large, it takes a long time until a desired image is displayed. Consequently, it is difficult to satisfy the need for quickly acquiring radiation image information required for a surgical operation.

According to the related art disclosed in Japanese Laid-Open Patent Publication No. 2005-296050, since the reduced image data for confirmation are sent from the radiation detector to the display device by way of wireless communications, the user can quickly confirm the detected radiation image information. However, as the radiation image information which is not reduced in size is sent from the radiation detector after the radiation detector is connected to the processor, it also takes a long time until radiation image information in a desired accuracy level is acquired and displayed.

According to the related art disclosed in Japanese Laid-Open Patent Publication No. 2002-248095, the preview image of the radiation image information is quickly displayed by the display device. The radiation detector and the processor are connected to each other by a signal cable for transmitting the uncompressed radiation image information. Therefore, if the processor is placed in an operating room, the signal cable may possibly present itself as an obstacle to a surgical operation performed in the operating room.

### SUMMARY OF THE INVENTION

It is a general object of the present invention to provide a radiation image capturing system which is capable of quickly displaying detected radiation image information for the user to confirm.

A major object of the present invention is to provide a radiation image capturing system which allows a display device and an image processor to be placed with a layout freedom for avoiding obstacles to an operation performed using the radiation image capturing system.

Another object of the present invention is to provide a radiation image capturing system which is suitable for use in an operating room or the like that contains a number of devices therein.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of an operating room incorporating a radiation image capturing system according to an embodiment of the present invention;

FIG. 2 is a perspective view, partly cut away, showing internal structural details of a radiation detecting cassette used in the radiation image capturing system;

FIG. 3 is a block diagram of a circuit arrangement of a radiation detector of the radiation detecting cassette shown in FIG. 2;

FIG. 4 is a block diagram of the radiation image capturing system;

FIG. 5 is a block diagram of a radiation image capturing system according to another embodiment of the present invention;

FIG. 6 is a perspective view showing another radiation detecting cassette used in the radiation image capturing system; and

FIG. 7 is a perspective view showing a cradle which charges the radiation detecting cassette.

### DESCRIPTION OF THE PREFERRED EMBODIMENTS

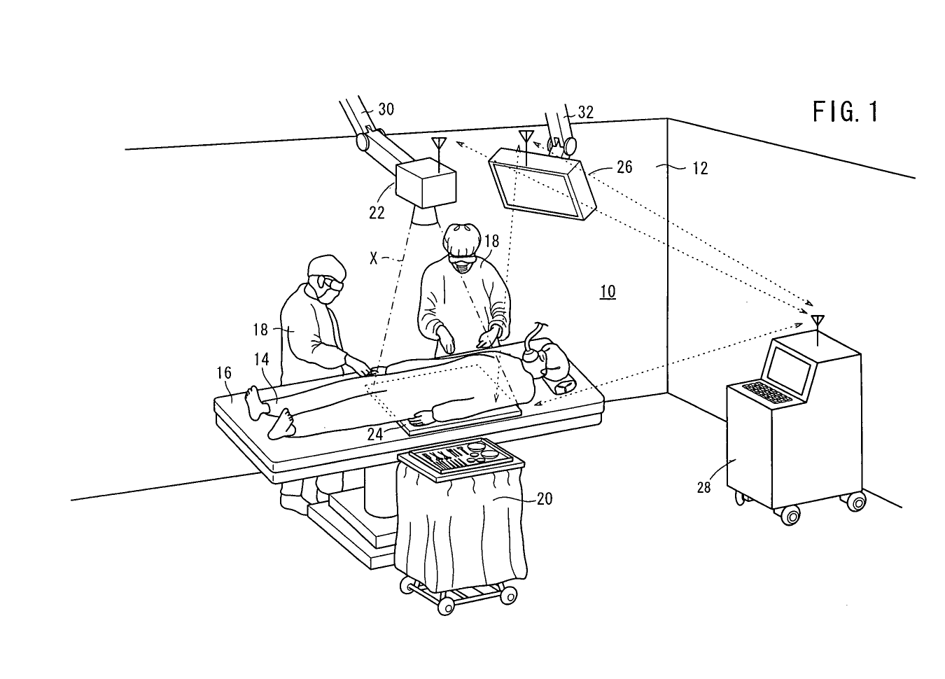

FIG. 1 shows in perspective an operating room 12 incorporating a radiation image capturing system 10 which employs a radiation detecting cassette 24 according to an embodiment of the present invention. As shown in FIG. 1, the operating room 12 has, in addition to the radiation image capturing system 10, a surgical table 16 for a patient 14 to lie thereon, and an instrument table 20 disposed on one side of the surgical table 16 for placing thereon various tools and instruments to be used by surgeons 18 for operating the patient 14. The surgical table 16 is surrounded by various apparatus required for surgical operations, including an anesthesia apparatus, an aspirator, an electrocardiograph, a blood pressure monitor, etc.

The radiation image capturing system 10 includes an image capturing apparatus 22 for irradiating the patient 14 with a radiation X at a dose according to image capturing conditions, a radiation detecting cassette 24 housing therein a radiation detector, to be described later, for detecting the radiation X that has passed through the patient 14, a display device 26 for displaying a radiation image based on the radiation X that is detected by the radiation detector 40, and a console (image processing device) 28 for controlling the image capturing apparatus 22, the radiation detecting cassette 24, and the display device 26. The image capturing apparatus 22, the radiation detecting cassette 24, the display device 26, and the console 28 send and receive signals by way of wireless communications.

The image capturing apparatus 22 is coupled to a universal arm 30 so as to be movable to a desired position for capturing a desired area of the patient 14 and also to be retractable to a position out of the way while the surgeons 18 are performing a surgical operation on the patient 14. Similarly, the display device 26 is coupled to a universal arm 32 so as to be movable to a position where the surgeons 18 can easily confirm a captured radiation image displayed on the display device 26.

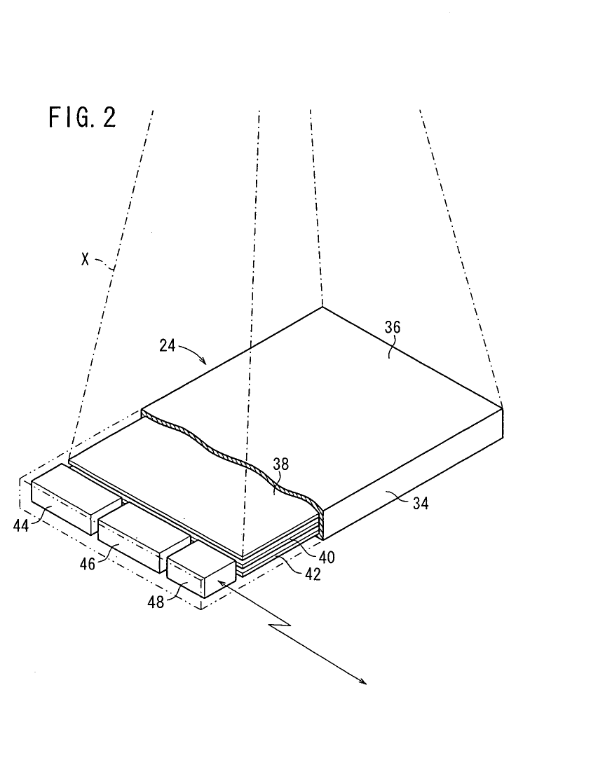

FIG. 2 shows internal structural details of the radiation detecting cassette 24. As shown in FIG. 2, the radiation detecting cassette 24 has a casing 34 made of a material permeable to the radiation X. The casing 34 houses therein a grid 38 for removing scattered rays of the radiation X from the patient 14, a radiation detector (radiation conversion panel) 40 comprising a solid-state detector for detecting the radiation X that has passed through the patient 14, and a lead plate 42 for absorbing back scattered rays of the radiation X. The grid 38, the radiation detector 40 and the lead plate 42 are successively arranged in that order from a surface 36 of the casing 34 which is irradiated with the radiation X. The irradiated surface 36 of the casing 34 may be constructed as the grid 38.

The casing 34 also houses therein a battery 44 as a power supply of the radiation detecting cassette 24, a cassette controller 46 for energizing the radiation detector 40 with electric power supplied from the battery 44, and a transceiver 48 for sending and receiving signals including the information of the radiation X detected by the radiation detector 40, to and from the display device 26 and the console 28. A shield plate of lead or the like should preferably be placed between the irradiated surface 36 of the casing 34 and the cassette controller 46 and the transceiver 48 to protect the cassette controller 46 and the transceiver 48 against damage which would otherwise be caused if irradiated with the radiation X.

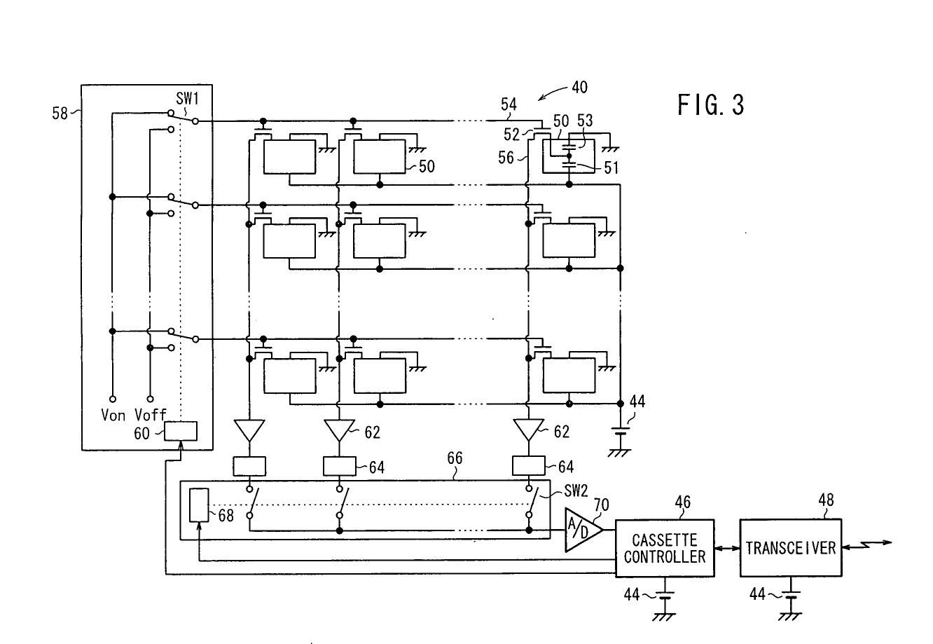

FIG. 3 shows in block form a circuit arrangement of the radiation detector 40. As shown in FIG. 3, the radiation detector 40 comprises an array of thin-film transistors (TFTs) 52 arranged in rows and columns, a photoelectric conversion layer 51 made of a material such as amorphous selenium (a-Se) for generating electric charges upon detection of the radiation X, the photoelectric conversion layer 51 being disposed on the array of TFTs 52, and an array of storage capacitors 53 connected to the photoelectric conversion layer 51. When the radiation X is applied to the radiation detector 40, the photoelectric conversion layer 51 generates electric charges, and the storage capacitors 53 store the generated electric charges. Then, the TFTs 52 are turned on along each row at a time to read the electric charges from the storage capacitors 53 as an image signal. In FIG. 3, the photoelectric conversion layer 51 and one of the storage capacitors 53 are shown as a pixel 50, and the pixel 50 is connected to one of the TFTs 52. Details of the other pixels 50 are omitted from illustration. Since amorphous selenium tends to change its structure and lose its function at high temperatures, it needs to be used in a certain temperature range. Therefore, some means for cooling the radiation detector 40 should preferably be provided in the radiation detecting cassette 24.

The TFTs 52 connected to the respective pixels 50 are connected to respective gate lines 54 extending parallel to the rows and respective signal lines 56 extending parallel to the columns. The gate lines 54 are connected to a line scanning driver 58, and the signal lines 56 are connected to a multiplexer 66 serving as a reading circuit.

The gate lines 54 are supplied with control signals Von, Voff for turning on and off the TFTs 52 along the rows from the line scanning driver 58. The line scanning driver 58 comprises a plurality of switches SW1 for switching between the gate lines 54 and an address decoder 60 for outputting a selection signal for selecting one of the switches SW1 at a time. The address decoder 60 is supplied with an address signal from the cassette controller 46.

The signal lines 56 are supplied with electric charges stored in the storage capacitors 53 of the pixels 50 through the TFTs 52 arranged in the columns. The electric charges supplied to the signal lines 56 are amplified by amplifiers 62 connected respectively to the signal lines 56. The amplifiers 62 are connected through respective sample and hold circuits 64 to the multiplexer 66. The multiplexer 66 comprises a plurality of switches SW2 for successively switching between the signal lines 56 and an address decoder 68 for outputting a selection signal for selecting one of the switches SW2 at a time. The address decoder 68 is supplied with an address signal from the cassette controller 46. The multiplexer 66 has an output terminal connected to an A/D converter 70. A radiation image signal generated by the multiplexer 66 based on the electric charges from the sample and hold circuits 64 is converted by the A/D converter 70 into a digital image signal representing radiation image information, which is supplied to the cassette controller 46.

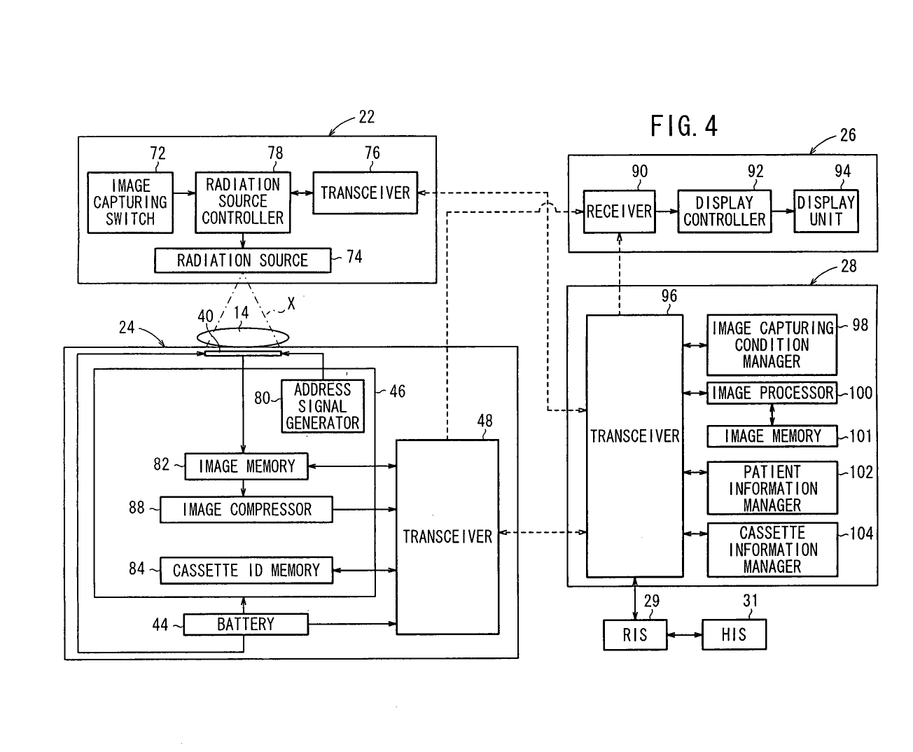

FIG. 4 shows in block form the radiation image capturing system 10 which comprises the image capturing apparatus 22, the radiation detecting cassette 24, the display device 26, and the console 28. The console 28 is connected to a radiology information system (RIS) 29 which generally manages radiation image information handled by the radiological department of the hospital and other information. The RIS 29 is connected to a hospital information system (HIS) 31 which generally manages medical information in the hospital.

The image capturing apparatus 22 comprises an image capturing switch 72, a radiation source 74 for outputting the radiation X, a transceiver 76 for receiving image capturing conditions from the console 28 by way of wireless communications and transmitting an image capturing completion signal, etc. to the console 28 by way of wireless communications, and a radiation source controller 78 for controlling the radiation source 74 based on an image capturing start signal supplied from the image capturing switch 72 and image capturing conditions supplied from the transceiver 76.

The radiation detecting cassette 24 houses therein the radiation detector 40, the battery 40, the cassette controller 46, and the transceiver (transmitter) 48. The cassette controller 46 comprises an address signal generator 80 for supplying address signals to the address decoder 60 of the line scanning driver 58 and the address decoder 68 of the multiplexer 66 of the radiation detector 40, an image memory 82 for storing the radiation image information detected by the radiation detector 40, a cassette ID memory 84 for storing cassette ID information for identifying the radiation detecting cassette 24, and an image compressor (amount-of-information reducer) 88 for compressing the radiation image information stored in the image memory 82 to reduce the amount of the radiation image information. The transceiver 48 receives a transmission request signal from the console 28 by way of wireless communications and transmits the cassette ID information stored in the cassette ID memory 84 and the radiation image information stored in the image memory 82 to the console 28 by way of wireless communications. The transceiver 48 also transmits the radiation image information compressed by the image compressor 88 to the display device 26 by way of wireless communications.

The display device 26 comprises a receiver 90 for receiving compressed radiation image information from the radiation detecting cassette 24 and uncompressed radiation image information from the console 28, a display controller 92 for controlling the display of the received radiation image information, and a display unit 94 for displaying the radiation image information processed by the display controller 92.

The console 28 comprises a transceiver (receiver, transmitter) 96 for transmitting and receiving necessary information including radiation image information to and from the image capturing apparatus 22, the radiation detecting cassette 24, and the display device 26 by way of wireless communications, an image capturing condition manager 98 for managing image capturing conditions required for the image capturing apparatus 22 to capture radiation images, an image processor 100 for processing radiation image information transmitted from the radiation detecting cassette 24, an image memory 101 for storing the radiation image information processed by the image processor 100, a patient information manager 102 for managing patient information of the patient 14 whose images are to be captured, and a cassette information manager 104 for managing cassette information transmitted from the radiation detecting cassette 24.

The console 28 may be located outside of the operating room 12 insofar as it can transmit and receive signals to and from the image capturing apparatus 22, the radiation detecting cassette 24, and the display device 26 by way of wireless communications.

The image capturing conditions refer to condition for determining a tube voltage, a tube current, an irradiation time, etc. required to apply a radiation X at an appropriate dose to an area to be imaged of the patient 14. The image capturing conditions may include an area to be imaged of the patient 14, an image capturing method, etc., for example. The patient information refers to information for identifying the patient 14, such as the name, gender, patient ID number, etc. of the patient 14. Ordering information for ordering the capture of an image, including the image capturing conditions and the patient information can be set directly on the console 28 or can be supplied from an external source to the console 28 via the RIS 29. The cassette information refers to cassette ID information for identifying the radiation detecting cassette 24.

The radiation image capturing system 10 according to the present embodiment is basically constructed as described above, and operation of the radiation image capturing system 10 will be described below.

The radiation image capturing system 10 is installed in the operating room 12 and used when a radiation image of the patient 14 is required by the surgeons 18 who are performing an operation on the patient 14. Before a radiation image of the patient 14 is captured, patent information of the patient 14 to be imaged is registered in the patient information manager 102 of the console 28. If an area to be imaged of the patient 14 and an image capturing method have already been known, they are registered as image capturing conditions in the image capturing condition manager 98. After the above preparatory process is finished, the surgeons 18 perform an operation on the patient 14.

For capturing a radiation image of the patient 14 during the operation, one of the surgeons 18 or the radiological technician places the radiation detecting cassette 24 in a given position between the patient 14 and the surgical table 16 with the irradiated surface 36 facing the image capturing apparatus 22. Then, after having moved the image capturing apparatus 22 to a position confronting the radiation detecting cassette 24, one of the surgeons 18 or the radiological technician turns on the image capturing switch 72 to capture a radiation image of the patient 14.

The radiation source controller 78 of the image capturing apparatus 22 requests the console 28 to transmit the image capturing conditions from the image capturing condition manager 98 via the transceivers 96, 76. Based on the request, the console 28 transmits the image capturing conditions about the area to be imaged of the patient 14 to the image capturing apparatus 22 via the transceivers 96, 76. When the radiation source controller 78 receives the image capturing conditions, it controls the radiation source 74 to apply a radiation X at a given dose to the patient 14 according to the image capturing conditions.

The radiation X which has passed through the patient 14 is applied to the grid 38, which removes scattered rays of the radiation X. Then, the radiation X is applied to the radiation detector 40, and converted into electric signals by the photoelectric conversion layer 51 of the pixels 50 of the radiation detector 40. The electric signals are stored as electric charges in the storage capacitors 53 (see FIG. 3). The stored electric charges, which represent radiation image information of the patient 14, are read from the storage capacitors 53 according to address signals which are supplied from the address signal generator 80 of the cassette controller 46 to the line scanning driver 58 and the multiplexer 66.

Specifically, in response to the address signal supplied from the address signal generator 80, the address decoder 60 of the line scanning driver 58 outputs a selection signal to select one of the switches SW1, which supplies the control signal Von to the gates of the TFTs 52 connected to the gate line 54 corresponding to the selected switch SW1. In response to the address signal supplied from the address signal generator 80, the address decoder 68 of the multiplexer 66 outputs a selection signal to successively turn on the switches SW2 to switch between the signal lines 56 for thereby reading the electric charges stored in the storage capacitors 53 of the pixels 50 connected to the selected gate line 54, through the signal lines 56.

The electric charges read from the storage capacitors 53 of the pixels 50 connected to the selected gate line 54 are amplified by the respective amplifiers 62, sampled by the sample and hold circuits 64, and supplied to the multiplexer 66. Based on the supplied electric charges, the multiplexer 66 generates and supplies a radiation image signal to the A/D converter 70, which converts the radiation image signal into a digital signal. The digital signal which represents the radiation image information is stored in the image memory 82 of the cassette controller 46.

Similarly, the address decoder 60 of the line scanning driver 58 successively turns on the switches SW1 to switch between the gate lines 54 according to the address signal supplied from the address signal generator 80. The electric charges stored in the storage capacitors 53 of the pixels 50 connected to the successively selected gate lines 54 are read through the signal lines 56, and processed by the multiplexer 66 and the A/D converter 70 into digital signals, which are stored in the image memory 82 of the cassette controller 46.

The radiation image information stored in the image memory 82 is read from the image memory 82 and compressed by the image compressor 88 to reduce the amount thereof. The compressed radiation image information is then transmitted from the transceiver 48 to the display device 26 by way of wireless communications. The image compressor 88 may compress the radiation image information according to any of various compression techniques comprising a lossy or lossless compression process such as a data decimating process, a bit compression process, a run-length compression process, etc., for example.

The radiation image information transmitted to the display device 26 is received by the receiver 90. In the display device 26, the display controller 92 controls the display unit 94 to display a compressed radiation image based on the radiation image information.

At this time, the radiation image information is quickly displayed because it has been compressed to reduce its amount. Based on the rough compressed image displayed on the display unit 94, the surgeons 18 can confirm in advance an outline of the range captured by the image capturing apparatus 22 and the status of the area to be operated on of the patient 14, and can take necessary actions, e.g., recapture radiation image information and perform a preparatory treatment of the area to be operated on of the patient 14.

At the same time that the radiation detecting cassette 24 transmits the compressed radiation image information to the display device 26, the radiation detecting cassette 24 reads the uncompressed radiation image information from the image memory 82 and transmits the read radiation image information from the transmitter 48 to the console 28 by way of wireless communications.

The radiation image information transmitted to the console 28 is received by the transceiver 96, processed by the image processor 100, and then stored in the image memory 101 in association with the patient information of the patient 14 registered in the patient information manager 102.

The radiation image information processed by the image processor 100 is transmitted from the transceiver 96 to the display device 26. In the display device 26, the receiver 90 receives the radiation image information, and the display controller 92 controls the display unit 94 to display a detailed radiation image based on the radiation image information, in place of the rough compressed image which has already been displayed. Inasmuch as the surgeons 18 have made preparatory actions based on the compressed image which has already been displayed, the surgeons 18 can surgically treat the patient 14 efficiently while confirming the detailed radiation image displayed on the display unit 94.

Since no cables for transmitting and receiving signals are connected between the radiation detecting cassette 24 and the console 28, between the image capturing apparatus 22 and the console 28, and between the console 28 and the display device 26, no such cables are placed on the floor of the operating room 12. Therefore, a tidy working environment is established in the operating room 12 to allow the surgeons 18 to work efficiently and smoothly without being hampered by obstacles such as cables.

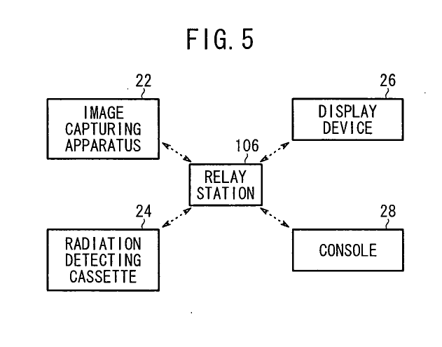

FIG. 5 shows in block form a radiation image capturing system according to another embodiment of the present invention. In FIG. 5, the image capturing apparatus 22, the radiation detecting cassette 24, the display device 26, and the console 28 of the radiation image capturing system 10 shown in FIG. 1 are interconnected by a relay station 106 of a wireless LAN. The image capturing apparatus 22, the radiation detecting cassette 24, the display device 26, and the console 28 thus interconnected are capable of sending and receiving a wider range of information therebetween.

In the radiation image capturing system 10 according to the illustrated embodiment, the radiation detector 40 housed in the radiation detecting cassette 24 directly converts the dose of the applied radiation X into an electric signal with the photoelectric conversion layer 51. However, the radiation image capturing system 10 may employ a radiation detector including a scintillator for converting the applied radiation X into visible light and a solid-state detecting device such as of amorphous silicon (a-Si) or the like for converting the visible light into an electric signal (see Japanese Patent No. 3494683).

Alternatively, the radiation image capturing system 10 may employ a light-conversion radiation detector for acquiring radiation image information. The light-conversion radiation detector operates as follows: When a radiation is applied to a matrix of solid-state detecting devices, the solid-state detecting devices store an electrostatic latent image depending on the dose of the applied radiation. For reading the stored electrostatic latent image, reading light is applied to the solid-state detecting devices to cause the solid-state detecting devices to generate an electric current representing radiation image information. When erasing light is applied to the radiation detector, radiation image information representing a residual electrostatic latent image is erased from the radiation detector, which can thus be reused (see Japanese Laid-Open Patent Publication No. 2000-105297).

When the radiation detecting cassette 24 is used in the operating room 12 or the like, the radiation detecting cassette 24 may be subjected to adhesion of blood, contamination, etc. However, when the radiation detecting cassette 24 is designed to have a waterproof and hermetically-sealed structure, and is sterilized and cleaned as necessary, one radiation detecting cassette 24 can be used repeatedly.

The radiation detecting cassette 24 is not limited to use in the operating room 12, and may be used for a medical examination and a round in the hospital.

Also, the radiation detecting cassette 24 may communicate with external devices via optical wireless communication using infrared light or the like, instead of general wireless communication using radio wave.

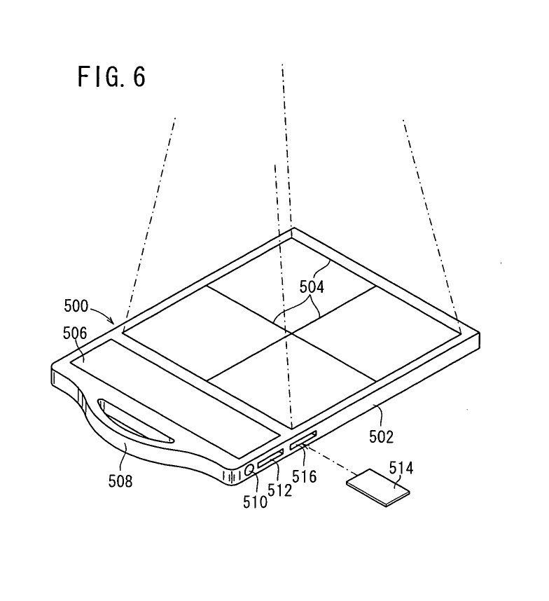

Preferably, the radiation detecting cassette 500 may be constructed as shown in FIG. 6.

Specifically, the radiation detecting cassette 500 includes a guiding line 504 drawn on the radiation-irradiated surface of a casing 502, the guiding line 504 serving as a reference for setting a captured area and a captured position. Using the guiding line 504, a subject can be positioned with respect to the radiation detecting cassette 500, and an area irradiated with the radiation can be set, thereby recording radiation image information on an appropriate captured area.

The radiation detecting cassette 500 is provided with a display section 506 on an area thereof other than the captured area, for displaying various information about the radiation detecting cassette 500. The information which is displayed on the display section 506, includes ID information of a subject whose radiation image information is to be recorded on the radiation detecting cassette 500, the number of times the radiation detecting cassette 500 has been used, an accumulated exposed radiation dose, a charging state (remaining battery level) of a battery 44 in the radiation detecting cassette 500, image capturing conditions of radiation image information, and a positioning image of the subject with respect to the radiation detecting cassette 500. In this case, a technician confirms a subject based on the ID information displayed on the display section 506, for example, and also previously confirms that the radiation detecting cassette 500 is placed in a usable state. Then, the technician positions a desired captured area of the subject with respect to the radiation detecting cassette 500 based on the displayed positioning image, thereby capturing appropriate radiation image information.

Also, the radiation detecting cassette 500 is provided with a handgrip 508, whereby it is easier to handle and carry the radiation detecting cassette 500.

Preferably, the radiation detecting cassette 500 may have, on a side thereof, an input terminal 510 for an AC adapter, a USB (Universal Serial Bus) terminal 512, and a card slot 516 for inserting a memory card 514.

When the charging function of the battery 44 in the radiation detecting cassette 500 becomes deteriorated, or when there is not enough time to fully charge the battery 44, the input terminal 510 is connected to the AC adapter to externally supply the radiation detecting cassette 500 with electric power, thereby enabling the radiation detecting cassette 500 to be used immediately.

The USB terminal 512 or the card slot 516 may be used when the radiation detecting cassette 500 cannot transmit and receive information to and from external devices such as the console 28 via wireless communication. Specifically, by connecting a cable to the USB terminal 512, the radiation detecting cassette 500 can transmit and receive information to and from the external devices via wire communication. Alternatively, the memory card 514 is inserted into the card slot 516, and necessary information is recorded on the memory card 514. After that, the memory card 514 is removed from the card slot 516, and the memory card 514 is inserted into the external device, thereby enabling information to be transferred.

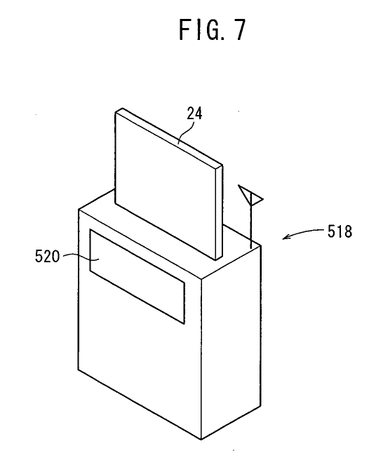

Preferably, a cradle 518 may be disposed in the operating room 12 or at a desired place in the hospital, into which the radiation detecting cassette 24 is inserted to charge the internal battery 44, as shown in FIG. 7. In this case, in addition to charging the battery 44, the cradle 518 may transmit and receive necessary information to and from external devices such as HIS 31, RIS 29, the console 28, etc. by way of wireless or wire communications of the cradle 518. The information may include radiation image information which is recorded on the radiation detecting cassette 24 inserted into the cradle 518.

Also, the cradle 518 may be provided with a display section 520. The display section 520 may display necessary information including a charging state of the inserted radiation detecting cassette 24 and radiation image information acquired from the radiation detecting cassette 24.

Further, a plurality of cradles 518 may be connected to a network. In this case, information about charging states of radiation detecting cassettes 24 inserted in respective cradles 518 can be collected through the network, and the radiation detecting cassette 24 in a usable state can be located.

Although certain preferred embodiments of the present invention have been shown and described in detail, it should be understood that various changes and modifications may be made therein without departing from the scope of the appended claims.

What is claimed is:

1. A radiation image capturing system comprising:
a cassette comprising a radiation conversion panel for detecting a radiation that has passed through a subject and converting the detected radiation into radiation image information, an amount-of-information reducer for reducing the amount of the radiation image information, a transmitter for transmitting said radiation image information to an external source by way of wireless communications, and a battery for supplying electric power to energize said radiation conversion panel, said amount-of-information reducer, and said transmitter;
an image processing device comprising a receiver for receiving the radiation image information, the amount of which is not reduced, from said cassette, an image processor for processing said radiation image information, and a transmitter for transmitting the processed radiation image information to an external source; and
a display device comprising a receiver for receiving the radiation image information, the amount of which is reduced, from said cassette, and the processed radiation image information from said image processing device, and a display unit for displaying the radiation image information, the amount of which is reduced, and the processed radiation image information.

2. A radiation image capturing system according to claim 1, wherein said amount-of-information reducer reduces the amount of the radiation image information by compressing said radiation image information.

3. A radiation image capturing system according to claim 1, wherein said transmitter of said image processing device transmits said radiation image information to said display device by way of wireless communications.

4. A radiation image capturing system according to claim 1, wherein said cassette and said display device are installed in an operating room.

5. A radiation image capturing system according to claim 1, wherein said cassette, said image processing device and said display device communicate with each other through a wireless LAN including a relay station.

6. A radiation image capturing system according to claim 1, further comprising
an image capturing apparatus for recording said radiation image information in said radiation conversion panel by applying said radiation to said subject, wherein said transmitter of said image processing device transmits image capturing conditions to said image capturing apparatus by way of wireless communications.

7. A radiation image capturing system according to claim 1, wherein said radiation conversion panel comprises a solid-state detector for converting said radiation into an electric signal.
